(19) United States
(12) Patent Application Publication
(10) Pub. No.: US 2021/0394759 A1
(43) Pub. Date: Dec. 23, 2021

(54) INFORMATION PROCESSING DEVICE, INFORMATION PROCESSING SYSTEM, INFORMATION PROCESSING METHOD, AND PROGRAM

(71) Applicant: TOYOTA JIDOSHA KABUSHIKI KAISHA, Toyota-shi (JP)

(72) Inventor: Takashi KITAGAWA, Kodaira-shi (JP)

(73) Assignee: TOYOTA JIDOSHA KABUSHIKI KAISHA, Toyota-shi (JP)

(21) Appl. No.: 17/246,776

(22) Filed: May 3, 2021

(30) Foreign Application Priority Data
Jun. 23, 2020 (JP) 2020-107739

(51) Int. Cl. B60W 30/18; H04W 4/40; H04W 4/029

(52) U.S. Cl. CPC B60W 30/18109; H04W 4/029; H04W 4/40; B60W 30/18018

(57) ABSTRACT

In an information processing device, a determining unit is configured to, based on vehicle information including positional information and speed information of a vehicle, and map information, determine whether a difference between a movement speed derived from the positional information of the vehicle and a speed of the vehicle based on the speed information at an intersection including a temporary stop line is less than a speed threshold value. A specifying unit is configured to, in a case where determination is made that the difference is less than the speed threshold value, specify a presence or absence of a temporary stop of the vehicle at the temporary stop line based on the vehicle information.

### CROSS-REFERENCE TO RELATED APPLICATION

This application claims priority to Japanese Patent Application No. 2020-107739 filed on Jun. 23, 2020, incorporated herein by reference in its entirety.

### BACKGROUND

### 1. Technical Field

The present disclosure relates to a technique for specifying whether a vehicle is temporarily stopped at a temporary stop line.

### 2. Description of Related Art

Japanese Unexamined Patent Application Publication No. 2015-125560 (JP 2015-125560 A) discloses a technique for detecting a vehicle traveling state of own vehicle from when the own vehicle approaches an intersection to when the own vehicle passes the intersection, and determining whether the vehicle is temporarily stopped before a temporary stop line from the detected vehicle traveling state.

### SUMMARY

With the technique disclosed in Japanese Unexamined Patent Application Publication No. 2015-125560 (JP 2015-125560 A), a position of the own vehicle is calculated from a signal received by a GPS receiver, and a road or an intersection on which the vehicle travels is specified from the calculated position of the own vehicle. Due to the influence of weather conditions, the calculated position of the own vehicle may be significantly shifted and may deviate significantly from the actual position. Therefore, there is a possibility that, even in a case where the vehicle does not actually pass the temporary stop line, determination is made as to whether the vehicle is temporarily stopped, and the determination accuracy decreases.

The present disclosure has been made in view of such a circumstance, and is to provide a technique capable of improving the accuracy of specifying a presence or absence of a temporary stop of a vehicle at a temporary stop line.

An aspect of the present disclosure relates to an information processing device including a determining unit and a specifying unit. The determining unit is configured to, based on vehicle information including positional information and speed information of a vehicle, and map information, determine whether a difference between a movement speed derived from the positional information of the vehicle and a speed of the vehicle based on the speed information at an intersection including a temporary stop line is less than a speed threshold value. The specifying unit configured to, in a case where determination is made that the difference is less than the speed threshold value, specify a presence or absence of a temporary stop of the vehicle at the temporary stop line based on the vehicle information.

Another aspect of the present disclosure relates to an information processing system. The information processing system includes a server device, and an on-vehicle device mounted on a vehicle and configured to acquire vehicle information including positional information and speed information of the vehicle and transmit the acquired vehicle information to the server device. The server device includes an acquiring unit, a determining unit, and a specifying unit. The acquiring unit is configured to acquire the vehicle information. The determining unit is configured to, based on the acquired vehicle information and map information, determine whether a difference between a movement speed derived from the positional information of the vehicle and a speed of the vehicle based on the speed information at an intersection including a temporary stop line is less than a speed threshold value. The specifying unit is configured to, in a case where determination is made that the difference is less than the speed threshold value, specify a presence or absence of a temporary stop of the vehicle at the temporary stop line based on the acquired vehicle information.

A still another aspect of the present disclosure relates to an information processing method. The method includes a step of determining, based on vehicle information including positional information and speed information of a vehicle, and map information, whether a difference between a movement speed derived from the positional information of the vehicle and a speed of the vehicle based on the speed information at an intersection including a temporary stop line is less than a speed threshold value, and a step of specifying, in a case where determination is made that the difference is less than the speed threshold value, a presence or absence of a temporary stop of the vehicle at the temporary stop line based on the vehicle information.

According to the present disclosure, the accuracy of specifying a presence or absence of a temporary stop of a vehicle at a temporary stop line can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of an information processing system according to an embodiment;

FIG. 2 is a diagram showing a travel trajectory of a vehicle that passes an intersection including a temporary stop line;

FIG. 3 is a diagram for describing a first condition of the embodiment;

FIG. 4 is a diagram for describing a second condition of the embodiment;

FIG. 5 is a graph showing a relationship between a speed and a time of a vehicle that travels on the intersection of FIG. 2;

FIG. 6 is a graph showing another example of the relationship between the speed and the time of the vehicle that travels on the intersection of FIG. 2; and

FIG. 7 is a flowchart showing a driving behavior determination process of a server device of FIG. 1.

### DETAILED DESCRIPTION OF EMBODIMENTS

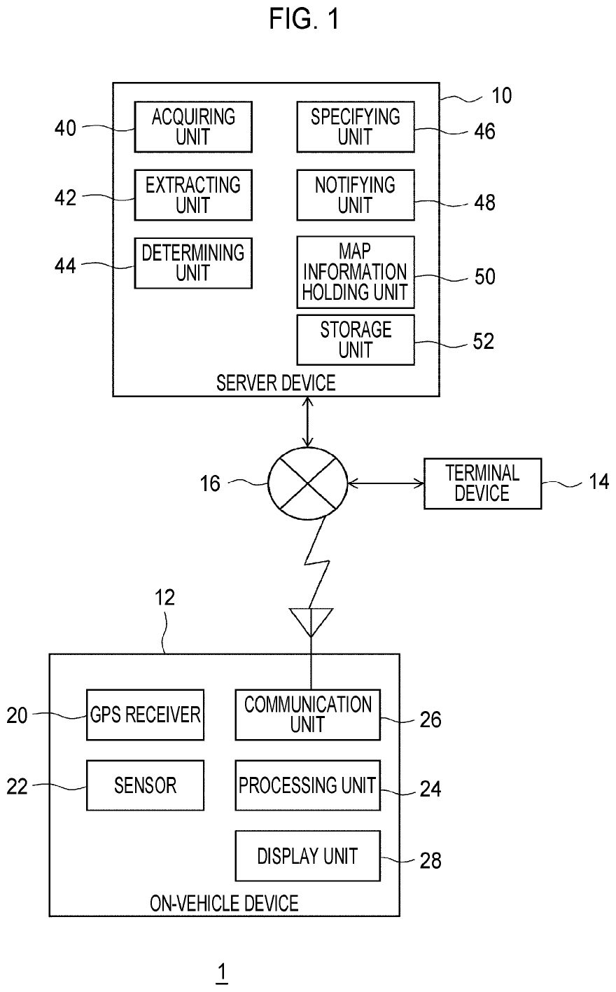

FIG. 1 is a block diagram of an information processing system 1 according to an embodiment. The information processing system 1 includes a server device 10, an on-vehicle device 12, and a terminal device 14. The on-vehicle device 12 is mounted on a vehicle that is an automobile. The on-vehicle device 12 has a wireless communication function and is connected to a network 16 via a wireless base station or a wireless access point. Although not shown, the information processing system 1 can include a plurality of the on-vehicle devices 12 mounted on different vehicles.

The terminal device 14 is a personal computer, a smartphone, or the like, is owned by the family of a driver of the vehicle, and is connected to the network 16 by the wireless communication or the wired communication. The server device 10 is connected to the network 16, and the server device 10 performs communication with the on-vehicle device 12 and the terminal device 14 via the network 16. The server device 10 is installed in a data center, and functions as an information processing device that processes data transmitted from the on-vehicle devices 12.

The on-vehicle device 12 includes a global positioning system (GPS) receiver 20, a sensor 22, a processing unit 24, a communication unit 26, and a display unit 28.

The GPS receiver 20 receives signals from GPS satellites and periodically derives the position of the vehicle. The position of the vehicle includes latitude and longitude. The GPS receiver 20 outputs positional information of the vehicle to the processing unit 24. A derived time is attached to the positional information.

The sensor 22 includes a speed sensor, periodically detects the speed of the vehicle, and outputs the detected speed information to the processing unit 24. A detected time is attached to the speed information.

The frequency with which the GPS receiver 20 derives the position and the frequency with which the sensor 22 detects the speed can be appropriately determined by an experiment or the like such that the presence or absence of a temporary stop at the temporary stop line described below can be specified, for example, the frequency may be several to several tens of times per second. These frequencies may be different.

The processing unit 24 acquires the positional information from the GPS receiver 20, acquires the speed information from the sensor 22, and outputs the vehicle information including the positional information and the speed information to the communication unit 26.

The communication unit 26 transmits the vehicle information received from the processing unit 24 to the server device 10. The frequency with which the communication unit 26 transmits the vehicle information is every time the traveling of the vehicle for one trip is completed or every predetermined period. Information for identifying the on-vehicle device 12 of a transmission source is attached to the vehicle information to be transmitted. The display unit 28 displays various information in accordance with the display control of the processing unit 24.

The server device 10 includes an acquiring unit 40, an extracting unit 42, a determining unit 44, a specifying unit 46, a notifying unit 48, a map information holding unit 50, and a storage unit 52. The configuration of the server device 10 can be realized by the CPU, memory, or other LSI of any computer in terms of hardware, and can be realized by a program loaded in the memory in terms of software, and here, the functional blocks realized by their cooperation are drawn. Therefore, it could have been understood by those skilled in the art that these functional blocks can be realized in various ways by hardware solely, software solely, or a combination thereof.

The server device 10 executes the driving behavior determination process described below periodically, for example, every trip, or at the frequency, such as once a day to once a week, for each on-vehicle device 12, that is, for each driver.

The acquiring unit 40 acquires the vehicle information transmitted from the on-vehicle device 12. The extracting unit 42 extracts the travel trajectory of the vehicle within a predetermined range of the intersection including the temporary stop line based on the positional information included in the vehicle information acquired by the acquiring unit 40 and the map information held in the map information holding unit 50. The travel trajectory is configured of a plurality of vehicle positions and can be said to be a history of changes in vehicle positions.

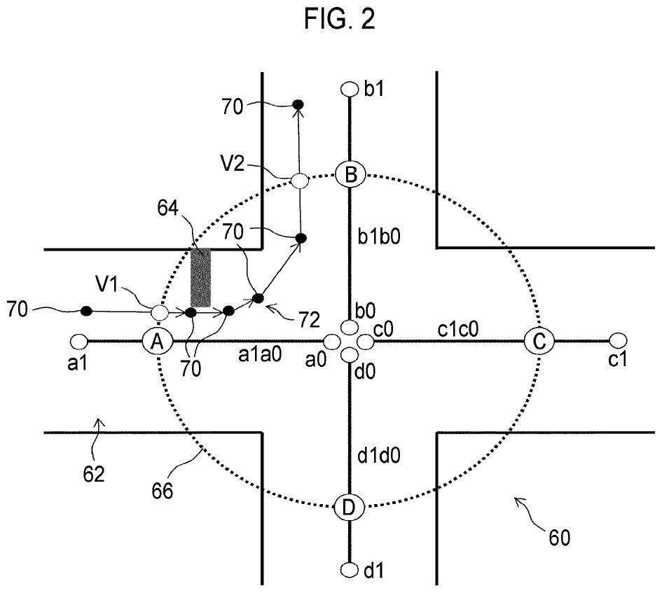

FIG. 2 is a diagram showing a travel trajectory 72 of the vehicle that passes an intersection 60 including a temporary stop line 64. Generally, in a digital road map used for car navigation, a road network is represented by a node representing a feature point of a road and a link connecting the nodes to represent the shape of the road (hereinafter, also referred to as a road link). The link corresponds to a road section. The map information of the map information holding unit 50 includes data of the link and the node.

The intersection 60 of FIG. 2 is represented by a link having a link number a1a0 connecting a node of a node number a1 and a node of a node number a0, a link of a link number b1b0 connecting a node of a node number b1 and a node of a node number b0, a link of a link number c1c0 connecting a node of a node number c1 and a node of a node number c0, and a link of a link number d1d0 connecting a node of a node number d1 and a node of a node number d0. Temporary stop line information indicating the existence of the temporary stop line is attached to the link of the link number a1a0 representing the road 62 on which the temporary stop line 64 is provided at the intersection 60.

The predetermined range is, for example, a range of a circle 66 having a predetermined radius from the center of the intersection 60. The predetermined radius may be the same at all intersections, may be set for each intersection depending on the size of the intersection, and may be set to, for example, 10 m to 20 m. The shape that defines the predetermined range is not limited to a circle, but may be a polygon, an ellipse, or the like. The shape that defines the predetermined range may be the same at all intersections, and may be set for each intersection depending on the shape of the intersection.

The extracting unit 42 sets intersecting points A, B, C, D between the circle 66 and each of the road links. Among the two intersecting points of the line connecting a plurality of vehicle positions 70 in the order of a derivation time and the circle 66, the extracting unit 42 defines an intersecting point on the vehicle position side in which the derivation time is early as V1 and an intersecting point on the vehicle position side in which the derivation time is late as V2. The extracting unit 42 specifies the road link on the intersecting point A closest to the intersecting point V1 as an approach road and the road link on the intersecting point B closest to the intersecting point V2 as an escaping road.

In a case where the temporary stop line information is attached to the road link of the approach road, the extracting unit 42 determines that the vehicle passes the temporary stop line, and extracts the travel trajectory 72 of the vehicle within the predetermined range of the intersection 60 including the temporary stop line 64. In a case where the temporary stop line information is not attached to the road link of the approach road, the extracting unit 42 does not extract the travel trajectory. As a result, the travel trajectory that passes the intersection in which the temporary stop line information is attached solely to the road links other than the approach road can be excluded, and thus the accuracy of specifying the presence or absence of the temporary stop can be improved.

The extracting unit 42 extracts the travel trajectory of the vehicle within the predetermined range of the intersection at each of the one or more intersections on which the vehicle passes the temporary stop line.

The determining unit 44 determines whether the travel trajectory satisfies a predetermined determination condition for each travel trajectory extracted by the extracting unit 42. The travel trajectory that satisfies the determination condition is a target for specifying the presence or absence of the temporary stop of the vehicle. The travel trajectory that does not satisfy the determination condition is excluded from the target for specifying the presence or absence of the temporary stop of the vehicle. This is because, as described below, there is a possibility that the travel trajectory that does not satisfy the determination condition does not actually pass the temporary stop line.

The determination condition includes at least one of following first condition to sixth condition. In a case where the determination condition includes a plurality of conditions, the determination condition is assumed to be satisfied in a case where all of the conditions are satisfied. The conditions included in the determination condition can be appropriately decided by an experiment. For example, in order to increase the probability that the travel trajectory satisfying the determination condition actually passes the temporary stop line as much as possible, the determination condition may include all of the first condition to the sixth condition.

First Condition

There is a possibility that an error occurs in the position of the vehicle derived by the GPS receiver 20 due to the influence of weather conditions or the like, and the vehicle position is significantly shifted and deviates significantly to the different position from the actual position. According to the first condition, a travel trajectory in which the vehicle position is significantly shifted as described above is excluded.

The first condition is that a difference between a movement speed derived based on the position of the vehicle derived by the GPS receiver 20 at the intersection including the temporary stop line and a speed of the vehicle detected by the sensor 22 at the intersection is less than a speed threshold value. The speed threshold value can be appropriately determined by an experiment, and may be, for example, about several tens of km/h to about 100 km/h.

A movement speed V(t) derived from the position of the vehicle at time t is expressed by the following equation (1).

V(t)=D(P(t),P(t−Δt))/Δt (1)

D(a, b) is a function representing a distance between a position a and a position b. P(t) is a function representing the position of the vehicle derived by the GPS receiver 20 at time t. At is a predetermined time interval, for example, 500 milliseconds.

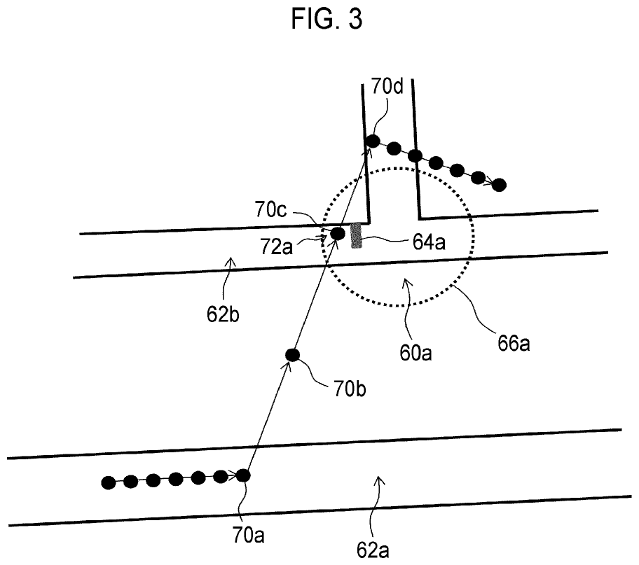

FIG. 3 is a diagram for describing the first condition of the embodiment. A vehicle position 70a is on a road 62a, but a vehicle position 70b is significantly shifted from the immediately preceding vehicle position 70a and is positioned outside the road 62a. A following vehicle position 70c and vehicle position 70d are also significantly shifted. For example, in a case where the derivation interval of the vehicle position is 0.1 second, the distance from the vehicle position 70a to the vehicle position 70d is assumed to be several tens of meters or larger.

A travel trajectory 72a is within a circle 66a at an intersection 60a. Since the temporary stop line information of a temporary stop line 64a is attached to the road link of an approach road 62b, the extracting unit 42 determines that the vehicle passes the temporary stop line, and extracts the travel trajectory 72a of the vehicle within the circle 66a of the intersection 60a including the temporary stop line 64a. However, the difference between the movement speed derived from the position of the vehicle at the intersection 60a and the speed of the vehicle based on the speed information is larger than the speed threshold value, and thus the first condition is not satisfied.

The travel trajectory 72a is considered to not actually pass the temporary stop line 64a. Since the first condition is not satisfied, the inaccurate travel trajectory 72a can be excluded from the target for specifying the presence or absence of the temporary stop of the vehicle, and thus the accuracy of specifying the presence or absence of the temporary stop can be improved.

The process corresponds to determination on whether, based on the acquired vehicle information and the map information, the difference between the movement speed derived from the positional information of the vehicle at the intersection including the temporary stop line and the speed of the vehicle based on the speed information is less than a speed threshold value by the determining unit 44.

Second Condition

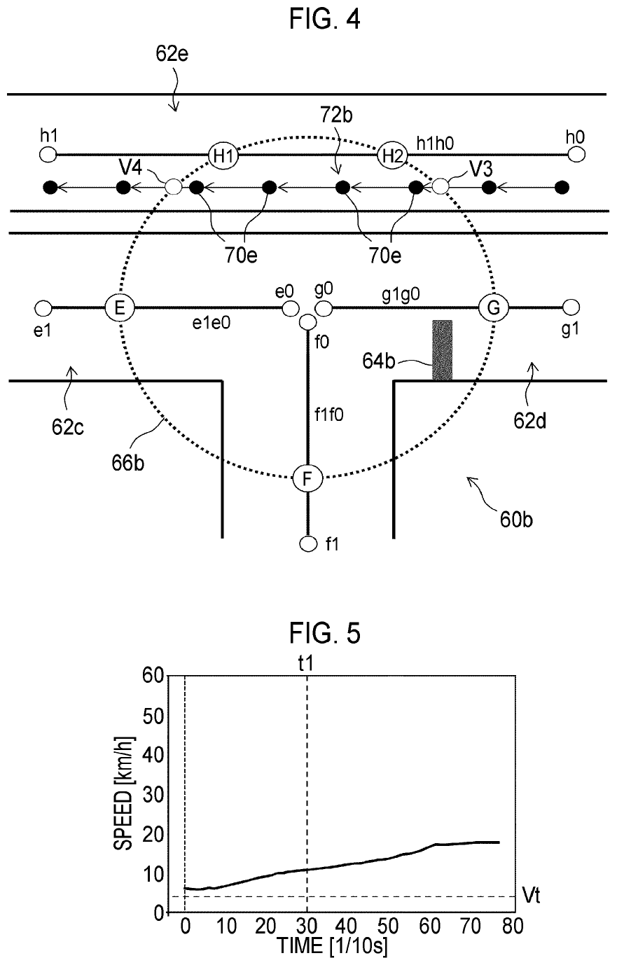

FIG. 4 is a diagram for describing the second condition of the embodiment. Another road 62e exists in the periphery of an intersection 60b that is not connected to the intersection 60b. Another road 62e is parallel to the road 62c and the road 62d that are connected to the intersection 60b.

Since a travel trajectory 72b on the other road 62e passes a circle 66b of the intersection 60b including a temporary stop line 64b, the extracting unit 42 extracts a travel trajectory 72b as the travel trajectory of the vehicle within the circle 66b of the intersection 60b. The travel trajectory 72b does not actually pass the temporary stop line 64b, and thus the travel trajectory 72b is excluded due to the second condition.

The second condition is that a first distance from the position of the vehicle to the road link at the intersection within the predetermined range of the intersection including the temporary stop line is shorter than a second distance from the position of the vehicle to the road link other than the intersection.

For example, the first distance is a straight line distance from an intersecting point V3 of the line connecting a plurality of vehicle positions 70e in the order of the derivation time and the circle 66b to an intersecting point G of the road link of a link number g1g0 and the circle 66b. The second distance is a straight line distance from the intersecting point V3 to an intersecting point H2 of the road link of a link number h1h0 and the circle 66b. The intersecting point V3 is the intersecting point on the vehicle position side in which the derivation time is early, and can be said to be an approach position of the vehicle to the intersection 60b.

The first distance may be a straight line distance from the intersecting point V4 of the line connecting the vehicle positions 70e in the order of the derivation time and the circle 66b to an intersecting point E of the road link of a link number e1e0 and the circle 66b, and the second distance may be a straight line distance from the intersecting point V4 to an intersecting point H1 of the road link of a link number h1h0 and the circle 66b. The intersecting point V4 is the intersecting point on the vehicle position side in which the derivation time is late, and can be said to be an escaping position of the vehicle to the intersection 60b.

The first distance may be the shortest distance from any vehicle position 70e within the circle 66b to the closest road link of the link number g1g0 or the link number e1e0, and the second distance may be the shortest distance from the same vehicle position 70e to the road link of the link number h1h0.

In the example of FIG. 4, the first distance is longer than the second distance, and the second condition is not satisfied. Therefore, the travel trajectory 72b can be excluded from the target for specifying the presence or absence of the temporary stop of the vehicle, and thus the accuracy of specifying the presence or absence of the temporary stop can be improved.

On the other hand, although not shown, in a case where the travel trajectory exists on the road 62c and the road 62d that are connected to the intersection 60b, the second condition is satisfied, and the presence or absence of the temporary stop can be specified.

The process corresponds to determination on whether, based on the acquired vehicle information and the map information, the first distance from the position of the vehicle to the road link at the intersection within the predetermined range of the intersection including the temporary stop line is shorter than the second distance from the position of the vehicle to the road link other than the intersection by the determining unit 44.

Third Condition

The third condition is that the approach road and the escaping road of the vehicle specified by the extracting unit 42 at the intersection including the temporary stop line are different road links. The approach road and the escaping road of the vehicle may be the same road link as in a case where the vehicle makes a U-turn. That is, the road link closest to the specified intersecting point V1 may be the same as the road link closest to the intersecting point V2. Since there is a possibility that the reliability of such a travel trajectory is low, such a travel trajectory is excluded. Accordingly, the accuracy of specifying the presence or absence of the temporary stop can be improved.

The process corresponds to determination on whether, based on the acquired vehicle information and the map information, the approach road and the escaping road of the vehicle at the intersection including the temporary stop line are the different road links by the determining unit 44.

Fourth Condition

The fourth condition is that an angle between an approach direction of the vehicle to the intersection including the temporary stop line or an escaping direction from the intersection and the road link other than the approach road and the escaping road that are connected to the intersection is a predetermined angle or larger. The predetermined angle may be, for example, 20°, and can be appropriately determined by an experiment.

For example, in a case where the angle between the two road links configuring the Y-shaped road is less than 20°, there is a possibility of not capable of distinguishing which road the vehicle actually travels due to an error in the vehicle position, and thus such a travel trajectory is excluded. Accordingly, the accuracy of specifying the presence or absence of the temporary stop can be improved.

The process corresponds to determination on whether, based on the acquired vehicle information and the map information, the angle between the approach direction of the vehicle to the intersection including the temporary stop line or the escaping direction from the intersection and the road link other than the approach road and the escaping road that are connected to the intersection is the predetermined angle or larger by the determining unit 44. For example, the determining unit 44 defines the direction from the vehicle position in which the derivation time is early before and after the intersecting point V1 specified by the extracting unit 42 to the vehicle position in which the derivation time is late as the approach direction of the vehicle to the intersection, and defines the direction from the vehicle position in which the derivation time is early before and after the intersecting point V2 specified by the extracting unit 42 to the vehicle position in which the derivation time is late as the escaping direction of the vehicle from the intersection.

Fifth Condition

The fifth condition is that the travel trajectory is extracted at the intersection including the temporary stop line in which no elevated road exists, such as an express way or a bridge, within a predetermined distance. The predetermined distance may be several tens of meters, for example, 20 m, and can be appropriately determined by an experiment.

For example, in a case where the intersection including the temporary stop line exists directly under the elevated road of the express way, there is a possibility that the vehicle actually travels on the express way and does not pass the temporary stop line, and thus the travel trajectory of such an intersection is excluded. Accordingly, the accuracy of specifying the presence or absence of the temporary stop can be improved.

The process corresponds to determination on whether, based on the acquired vehicle information and the map information, the travel trajectory is extracted at the intersection including the temporary stop line in which no elevated road exists within the predetermined distance by the determining unit 44. For example, in a case where elevated road information is attached to the road link within the predetermined distance of the intersection that is the determination target, the determining unit 44 determines that the travel trajectory is extracted at the intersection including the temporary stop line in which the elevated road exists within the predetermined distance.

Sixth Condition

The sixth condition is that the travel trajectory is extracted at the intersection including the temporary stop line in which no side road that joins diagonally exists. The side road that joins diagonally means a side road in which an angle between a link of the side road and a link of the road that joins is a predetermined angle or less. The predetermined angle may be the same as or different from the predetermined angle of the fourth condition. Such a side road is assumed to have the temporary stop line and the joined road is assumed not to have the temporary stop line, but there is a possibility of not capable of distinguishing that the road on which the vehicle actually travels is the side road or the joined road due to the error in the position of the vehicle. Therefore, the travel trajectory of the intersection in which such a side road exists is excluded. Accordingly, the accuracy of specifying the presence or absence of the temporary stop can be improved.

The process corresponds to determination on whether, based on the acquired vehicle information and the map information, the travel trajectory is extracted at the intersection including the temporary stop line in which no side road that joins diagonally exists by the determining unit 44.

Solely in a case where the determining unit 44 determines that the travel trajectory satisfies a predetermined condition, the specifying unit 46 specifies the presence or absence of the temporary stop of the vehicle at the temporary stop line related to the travel trajectory based on the vehicle information acquired by the acquiring unit 40.

Specifically, the specifying unit 46 specifies that there is a temporary stop in a case where the vehicle speed within the predetermined range of the intersection extracted from the travel trajectory satisfying the predetermined condition and the minimum speed of the vehicle speed within a predetermined time immediately before the approaching the predetermined range of the intersection is a stop threshold value or less. In a case where the minimum speed of these vehicle speeds is higher than the stop threshold value, the specifying unit 46 specifies that there is no temporary stop. The predetermined time may be several seconds, for example, about 3 seconds, the stop threshold value may be several km/h, for example, about 4 km/h, and the predetermined time and the stop threshold value can be appropriately determined by experiments.

FIG. 5 shows a relationship between the speed and the time of the vehicle that travels on the intersection 60 of FIG. 2. The vehicle approaches the circle 66 at the intersection 60 at a timing t1. The vehicle speed is higher than the stop threshold value Vt (=4 km/h) from 3 seconds before timing t1 to the time when the vehicle escapes from the circle 66 of about 4.5 seconds after timing t1. Therefore, the specifying unit 46 specifies that there is no temporary stop.

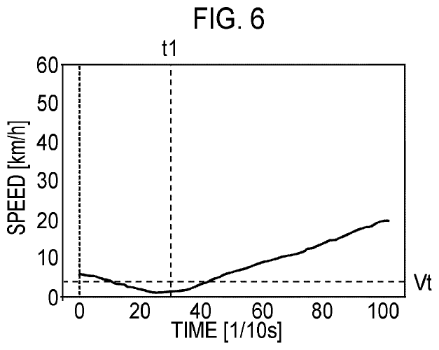

FIG. 6 shows another example of the relationship between the speed and the time of the vehicle that travels on the intersection 60 of FIG. 2. The minimum speed of the vehicle speed from 3 seconds before timing t1 when the vehicle approaches the circle 66 at the intersection 60 to the time when the vehicle escapes from the circle 66 of about 7 seconds after timing t1 is the stop threshold value Vt or less. Therefore, the specifying unit 46 specifies that there is the temporary stop.

The specifying unit 46 stores the specified presence or absence of the temporary stop in the storage unit 52 in association with accessory information, such as a driver's ID, sensor data, and date and time information.

The notifying unit 48 notifies at least one of the on-vehicle device 12 and the terminal device 14 of the specification result of the presence or absence of the temporary stop stored in the storage unit 52. The notified specification result of the presence or absence of the temporary stop is displayed on at least one of the display unit 28 of the on-vehicle device 12 and the display unit (not shown) of the terminal device 14. Therefore, the driver and the driver's family can be made to recognize whether the driver takes driving behavior not to temporarily stop at the temporary stop line.

After traveling for one trip, the specifying unit 46 may perform a driving diagnosis in accordance with the number of intersections on which the temporary stop is specified among a plurality of intersections including the temporary stop line that the vehicle pass. For example, the specifying unit 46 may convert a ratio of the number of the intersections at which the vehicle is temporarily stopped among the intersections including the temporary stop line that the vehicle passes into a score and store the score in the storage unit 52. The notifying unit 48 may notify at least one of the on-vehicle device 12 and the terminal device 14 of the score stored in the storage unit 52.

The specification result and the score of the presence or absence of the temporary stop stored in the storage unit 52 can be used, for example, for calculating the insurance premium rate of automobile insurance.

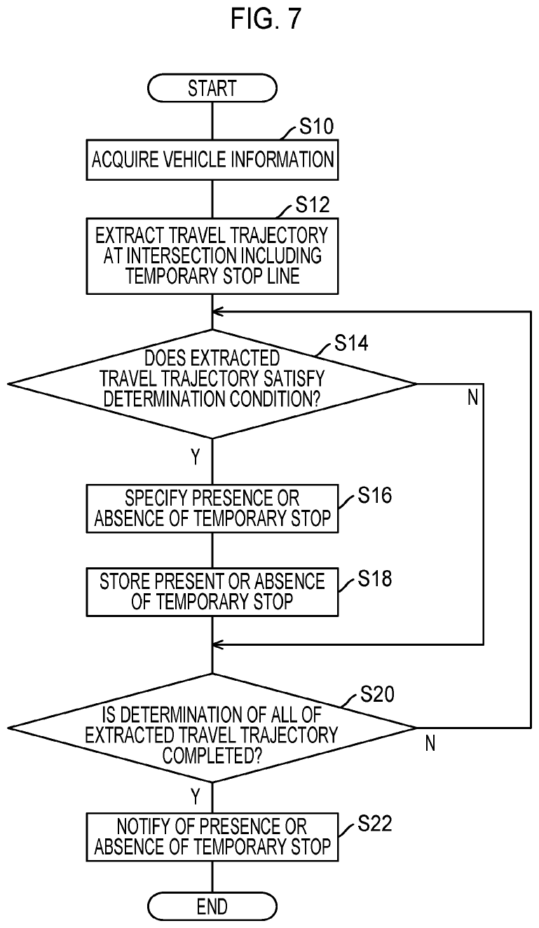

FIG. 7 is a flowchart showing a driving behavior determination process of the server device 10 of FIG. 1. This process is executed for each on-vehicle device 12. The acquiring unit 40 acquires the vehicle information transmitted from the on-vehicle device 12 (S10), and the extracting unit 42 extracts the travel trajectory of the vehicle within the predetermined range of the intersection including the temporary stop line (S12).

Subsequent processes of S14 to S18 are executed for each travel trajectory extracted in S12. In a case where the extracted travel trajectory satisfies the determination condition (Y in S14), the specifying unit 46 specifies the presence or absence of the temporary stop (S16), and the storage unit 52 stores the specified presence or absence of the temporary stop (S18), in a case where the determination of all of the extracted travel trajectories is not completed (N in S20), the process returns to S14. In a case where the extracted travel trajectory does not satisfy the determination condition (N in S14), the process proceeds to S20. In a case where the determination of all of the extracted travel trajectories is completed (Y in S20), the notifying unit 48 notifies of the presence or absence of the temporary stop (S22), and the process is completed.

According to the present embodiment, since the presence or absence of the temporary stop of the vehicle at the temporary stop line is specified solely in a case where the predetermined condition is satisfied, the accuracy of specifying the presence or absence of the temporary stop can be improved.

The present disclosure has been described above based on the embodiment. The embodiment is merely examples, and it could have been understood by those skilled in the art that various modification examples are possible for each component and combination of each processing process, and that such modification examples are also within the scope of the present disclosure.

In the embodiment, the server device 10 executes the driving behavior determination process, but the on-vehicle device 12 may execute the process. In this case, the on-vehicle device 12 further includes the acquiring unit 40, the extracting unit 42, the determining unit 44, the specifying unit 46, the notifying unit 48, the map information holding unit 50, and the storage unit 52, and the on-vehicle device 12 functions as the information processing device. In this case, the server device 10 may not be provided, or the server device 10 may collect specification results of presence or absence of the temporary stop from each of the on-vehicle devices 12. In this modification example, the degree of freedom in the configuration of the information processing system 1 can be improved.

In the embodiment, one server device 10 is provided, but the server device 10 may be divided into two devices. That is, the server device 10 may include a first server device including the acquiring unit 40, and a second server device including the extracting unit 42, the determining unit 44, the specifying unit 46, the notifying unit 48, the map information holding unit 50, and the storage unit 52. The first server device directly acquires the vehicle information transmitted from each of the on-vehicle devices 12, and provides the acquired vehicle information to the second server device. The second server device indirectly acquires vehicle information of a plurality of vehicles provided by the first server device, and executes the driving behavior determination process based on the acquired vehicle information. Also, in this modification example, the degree of freedom in the configuration of the information processing system 1 can be improved.

Further, the map information holding unit 50 may hold the map information excluding the intersection that does not satisfy the fifth condition or the sixth condition in advance. As a result, it is possible to reduce the amount of processes of extracting the travel trajectory of the vehicle at the intersection including the temporary stop line.

In the embodiment, the driving behavior determination process is executed periodically, for example, every trip, or at the frequency, such as once a day to once a week, but the driving behavior determination process may be executed in real time every time the vehicle passes the intersection including the temporary stop line. In this case, the on-vehicle device 12 transmits the vehicle information to the server device 10 in real time. In this modification example, the driver can be notified in real time of the specification result of the presence or absence of the temporary stop.

What is claimed is:

1. An information processing device comprising:
a determining unit configured to, based on vehicle information including positional information and speed information of a vehicle, and map information, determine whether a difference between a movement speed derived from the positional information of the vehicle and a speed of the vehicle based on the speed information at an intersection including a temporary stop line is less than a speed threshold value; and
a specifying unit configured to, in a case where determination is made that the difference is less than the speed threshold value, specify a presence or absence of a temporary stop of the vehicle at the temporary stop line based on the vehicle information.

2. An information processing system comprising:
a server device; and
an on-vehicle device mounted on a vehicle and configured to acquire vehicle information including positional information and speed information of the vehicle and transmit the acquired vehicle information to the server device,
wherein the server device includes
an acquiring unit configured to acquire the vehicle information,
a determining unit configured to, based on the acquired vehicle information and map information, determine whether a difference between a movement speed derived from the positional information of the vehicle and a speed of the vehicle based on the speed information at an intersection including a temporary stop line is less than a speed threshold value, and
a specifying unit configured to, in a case where determination is made that the difference is less than the speed threshold value, specify a presence or absence of a temporary stop of the vehicle at the temporary stop line based on the acquired vehicle information.

3. A program that causes a computer to execute
a step of determining, based on vehicle information including positional information and speed information of a vehicle, and map information, whether a difference between a movement speed derived from the positional information of the vehicle and a speed of the vehicle based on the speed information at an intersection including a temporary stop line is less than a speed threshold value, and
a step of specifying, in a case where determination is made that the difference is less than the speed threshold value, a presence or absence of a temporary stop of the vehicle at the temporary stop line based on the vehicle information.

4. An information processing method comprising:
a step of determining, based on vehicle information including positional information and speed information of a vehicle, and map information, whether a difference between a movement speed derived from the positional information of the vehicle and a speed of the vehicle based on the speed information at an intersection including a temporary stop line is less than a speed threshold value; and
a step of specifying, in a case where determination is made that the difference is less than the speed threshold value, a presence or absence of a temporary stop of the vehicle at the temporary stop line based on the vehicle information.
